(19) United States
(12) Patent Application Publication
(10) Pub. No.: US 2011/0071904 A1
(43) Pub. Date: Mar. 24, 2011

(54) METHOD FOR TRANSMITTING ADVERTISEMENTS TO COMMUNICATION DEVICE

(75) Inventor: JENG YEN PENG, TAIPEI COUNTY (TW)

(73) Assignee: LEADTEK RESEARCH INC., TAIPEI HSIEN (TW)

(21) Appl. No.: 12/648,185

(22) Filed: Dec. 28, 2009

(30) Foreign Application Priority Data
Sep. 18, 2009 (TW) 098131472

(51) Int. Cl. G06Q 30/00; G06F 17/30

(52) U.S. Cl. 705/14.54; 707/724; 707/722; 707/E17.017

(57) ABSTRACT

A method for transmitting advertisements to a communication device comprises the steps of: a communication device transmitting a search instruction to a content aggregating apparatus, wherein the search instruction comprises at least a keyword, the location of the communication device, a user account and a time stamp; performing an Internet search based on the given keyword and the location of the communication device; optimizing the search results; transmitting the optimized results in an XML format to the communication device; transmitting advertisements to the communication device according to the keywords and the location of the communication device; providing a short message to an inbox of the communication device according to the advertisement; and notifying a user of the incoming short message.

### BACKGROUND OF THE INVENTION

1. Field of the Invention

The present invention relates to a method for transmitting advertisements, and more particularly, to a method for transmitting advertisements to communication apparatus.

2. Description of the Related Art

As the Internet emerges from its infancy and out of the Web 1.0 era, Web 2.0 emerges as the new generation of network applications. The Netscape web browser is a typical example of Web 1.0. The Netscape browser provides users with access to Internet servers, giving users capability for communication with the Internet. With Web 2.0, more emphasis is placed on content integration and sharing than on one-way communication from the Internet. Under the concept of Web 2.0, the Internet is considered a platform, and users are encouraged to share content so as to enrich the resources available to other users. The Google search engine is a typical example of Web 2.0. Compared to the Netscape web browser, the Google search engine possesses the capability of database management, which shows that content is more important in Web 2.0 than in Web 1.0.

Mashup is another concept in Web 2.0. The concept of mashup is to integrate information from different sources or with different elements together to share with other users. Google Map is an application of the mashup concept. Mashup applications represent convenient and fast information integration, and the integrated information is generated by accessing open application program interface (API) and information sources. In addition, internet service providers (ISP) can provide related advertisements to users based on keywords those users use for searching the Internet. For instance, the application AdSense, a popular advertising program provided by Google, can simultaneously provide links to the searched content and links to advertisements related to the search topic. Google charges the advertisers based on the number of times their links are clicked. However, since web browsers do not have the user's location, they fail to provide the users with more convenient, location-specific information.

For mobile communication devices, some ISPs also apply the concept of Web 2.0 to mobile search applications. Users can search information on the Internet via ISPs based on the user's present location and keywords typed. In addition, among the estimated 2.5 billion mobile phone users worldwide, about 74% use Short Message Service (SMS). As a result, transmitting by short message has become the main approach to transmitting advertisements to mobile communication devices.

Accordingly, it can be deduced that by combining the mobile search applications provided by ISPs with transmitted SMS advertisements, a new service similar to the AdSense application can be provided to users. However, previous technology would have required the advertiser to pay advertising costs to the ISPs as well as the cost of each short message sent to the ISPs. Further, since there are many ISPs, and most users contract with only one ISP, advertisers would need to cooperate with multiple ISPs in order to reach a broad range of users. Under such constraints, advertising would be expensive and advertising management would be quite complicated.

Therefore, there is a need to provide a method for transmitting advertisements to communication devices that does not include charging users, is not limited to only those ISPs the users contract with, and does not incur costs for short message transmission.

### SUMMARY OF THE INVENTION

The present invention provides a method for transmitting advertisements to a communication device in which an Internet search is performed based on one or more keywords provided by the communication device. Integrated with the location of the communication device, the search result is then converted from hypertext markup language (HTML) format to extensible markup language (XML) format, and then is transmitted to the communication device. Meanwhile, related advertisements are also transmitted to the communication device based on the search keywords and the location of the communication device. The communication device retrieves the advertisement in an SMS format.

The method for transmitting advertisements to a communication device according to one embodiment of the present invention comprises the steps of: a communication device transmitting a search instruction to a content aggregating apparatus, wherein the search instruction comprises one or more keywords, the location of the communication device, a user account and a time stamp; the content aggregating apparatus performing an Internet search based on the given keywords and the location of the communication device; the content aggregating apparatus optimizing the search results; the content aggregating apparatus transmitting the optimized content in an XML format via the Internet to the communication device; the content aggregating apparatus transmitting advertisements to the communication device according to the search keywords and the location of the communication device; a watchdog program of the communication device providing a short message to appear in the inbox of the communication device according to the advertisement; and the inbox notifying a user of the short message stored in the inbox.

The content aggregating apparatus according to one embodiment of the present invention comprises an HTTP processor, a content searching and processing module, an HTTP analysis and filter module, a mashup engine and an XML encoder. The HTTP processor is configured to fetch the searching instruction. The content searching and processing module is configured to search the Internet based on one or more keywords and the location of the communication device. The HTTP analysis and filter module is configured to optimize the search results. The mashup engine is configured to integrate the optimized search results. The XML encoder is configured to encode the integrated search results in an XML format.

### BRIEF DESCRIPTION OF THE DRAWINGS

The objectives and advantages of the present invention will become apparent upon reading the following description and upon referring to the accompanying drawings of which:

FIG. 1 shows a system of transmitting advertisements to a communication device according to one embodiment of the present invention;

FIG. 2 shows a flow chart of a method for transmitting advertisements to a communication device according to one embodiment of the present invention;

FIG. 3 shows a flow for transmitting advertisements to a communication device according to one embodiment of the present invention;

FIG. 4 shows a schematic view of a user interface of a mobile communication device according to one embodiment of the present invention;

FIG. 5 shows a schematic view of a user interface of a mobile communication device according to another embodiment of the present invention;

FIG. 6 shows a content aggregating apparatus according to one embodiment of the present invention; and

FIG. 7 shows a method for transmitting advertisements to a communication device according to one embodiment of the present invention.

### DETAILED DESCRIPTION OF THE INVENTION

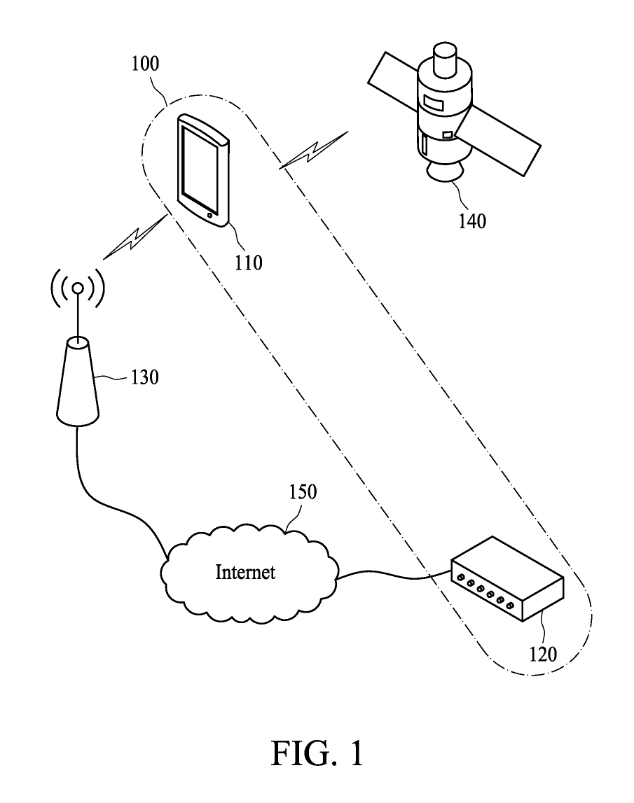

FIG. 1 shows a system of transmitting advertisements to a communication device according to one embodiment of the present invention. As shown in FIG. 1, the system 100 comprises a mobile communication device 110 and a content aggregating apparatus 120. The mobile communication device 110 is provided with an installed software program, which when executed can transmit advertisements to a communication device according to one embodiment of the present invention. The mobile communication device 110 communicates with the content aggregating apparatus 120 by connecting to the Internet 150 via a base station 130. In addition, if the mobile communication device 110 is provided with satellite positioning functionality, a satellite 140 can provide the mobile communication device 110 with its location information, e.g. the latitude and longitude coordinates of the mobile communication device 110.

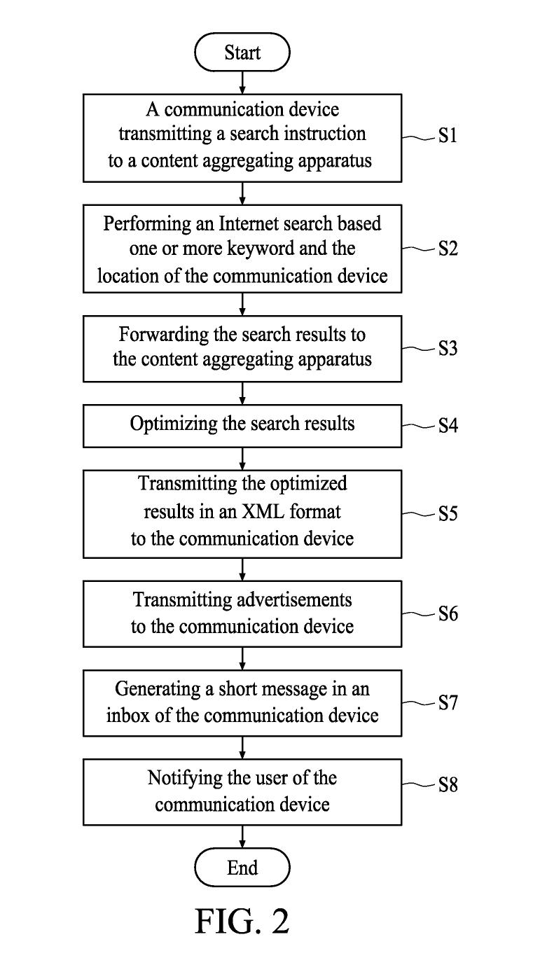

FIG. 2 shows a flow chart of a method for transmitting advertisements to a communication device according to one embodiment of the present invention. In step S1, a communication device transmits a search instruction to a content aggregating apparatus, and then step S2 is executed. The search instruction comprises at least a keyword, the location of the communication device, a user account and a time stamp. In some embodiments of the present invention, the communication device may be a mobile phone, a video phone or a personal digital assistant. In step S2, the content aggregating apparatus performs an Internet search by a search engine based on the given keywords and the location of the communication device, and then step S3 is executed. In some embodiments of the present invention, the search engine may be the Google search engine. In step S3, the search results are then forwarded by the search engine to the content aggregating apparatus, and then step S4 is executed. In step S4, the content aggregating apparatus optimizes the search results, and then step S5 is executed. In step S5, the content aggregating apparatus transmits the optimized results in an XML format via the Internet to the communication device, and then step S6 is executed.

In step S6, an advertisement engine, which is in the content aggregating apparatus and monitors user preference, transmits advertisements through the Internet to the communication device according to the given keywords, the location of the communication device and an advertising policy, and then step S7 is executed. In step S7, a watchdog program of the communication device generates a short message according to the advertisement and stores the message in an inbox of the communication device, and then step S8 is executed. In step S8, the inbox notifies the user of the short message stored in the inbox.

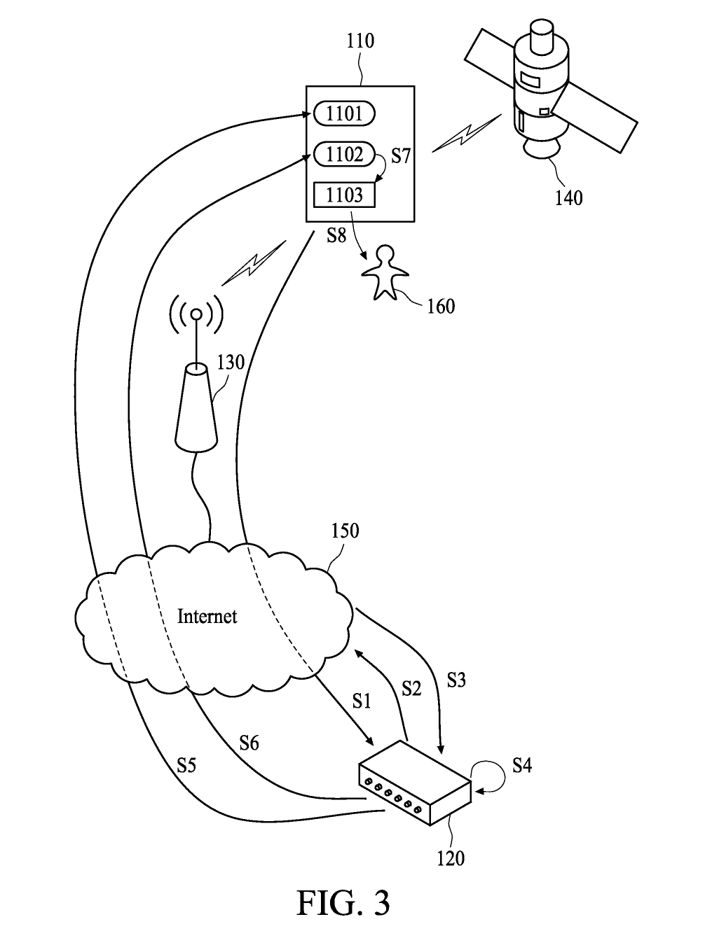

FIG. 3 shows application of the method for transmitting advertisements to a communication device shown in FIG. 2 to the system of transmitting advertisements to the communication device shown in FIG. 1. As mentioned, the mobile communication device 110 is operated by a user 160, and is provided with an installed software program, which when executed can perform the method for transmitting advertisements to a communication device shown in FIG. 2. The software program comprises two application programs. One application program 1101 is configured to process the search results in XML format provided by the content aggregating apparatus 120. Another application program 1102 is a watchdog program, e.g. a daemon, and is configured to generate a short message according to the received advertisement, wherein the short message is then stored in the inbox 1103 of the mobile communication device 110. The mobile communication device 110 logs in to the content aggregating apparatus 120 when it is turned on. If the mobile communication device 110 has never logged in before, registration of a user account and password is required.

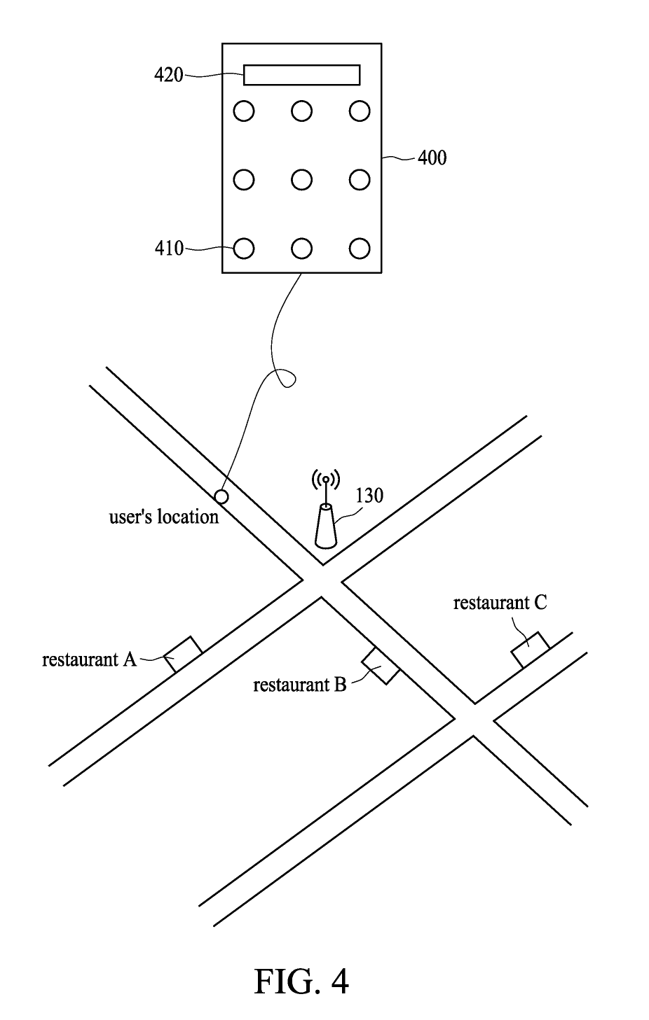

FIG. 4 shows a schematic view of a user interface of a mobile communication device according to one embodiment of the present invention. As shown in FIG. 4, the mobile communication device 110, which can connect to 3G networks, is located at the user's location. The user of the mobile communication device 110 wishes to search for restaurants in his or her vicinity. As shown in FIG. 4, a program installed in the mobile communication device 110 displays a user interface 400 on the screen of the mobile communication device 110. The user interface 400 comprises a plurality of shortcut keys 410 and a keyword display column 420. Each shortcut key may correspond to a key of the mobile communication device 110. When searching for information on the Internet using the mobile communication device 110, the user 160 can manually input keywords, which will be displayed on the keyword display column 420, or input keywords by pressing the key corresponding to the shortcut keys 410. These shortcut keys 410 comprise news searching, restaurant searching, parking lot searching, shopping, café searching, convenience store searching, friend searching, hotel searching, e-learning and the location of the communication device. In this embodiment, the user 160 either uses these shortcut keys 410 or manually inputs a keyword, for example the keyword restaurant. If the mobile communication device 110 is provided with a satellite positioning function, and the mobile communication device 110 is currently located at a position where the satellite positioning function is functional, then the mobile communication device 110 can define its position based on latitude and longitude coordinates provided by the satellite 140. If the mobile communication device 110 is not provided with a satellite positioning function, or if the mobile communication device 110 is currently located at a position where the satellite positioning function is not functional, e.g. an indoor environment, the mobile communication device 110 can define its position based on the cell ID of the base stations 130 shown in FIG. 3.

Referring to FIG. 3, in step S1, the user 160 inputs the keyword restaurant into the mobile communication device 110. The mobile communication device 110 then transmits a search instruction to the content aggregating apparatus 120, wherein the searching instruction comprises the keyword restaurant, the location of the mobile communication device 110, a user account of the mobile communication device 110 and a time stamp of the generation time of the searching instruction. In some embodiments of the present invention, the user account and the time stamp serve as bases for charging advertisers the fee for the advertisement. In step S2, the content aggregating apparatus 120 performs an Internet search 150 by a search engine based on the keyword restaurant and the location of the mobile communication device 110. In step S3, the search results are forwarded by the search engine to the content aggregating apparatus 120. In step S4, the content aggregating apparatus 120 optimizes the search results. In some embodiments of the present invention, the content aggregating apparatus 120 searches the Internet 150 based on specific weightings, which may be constructed according to distances between the locations of the stores that sell the searched item and the mobile communication device 110, operating hours of the stores that sell the searched item, and the amount of the advertising purchased by the stores that sell the searched item. In this embodiment, the businesses meeting the search criteria, i.e., that sell the searched item, are the restaurants A, B and C shown in FIG. 4. In step S5, the content aggregating apparatus 120 transmits the optimized content in an XML format via the Internet 150 to the communication device 110.

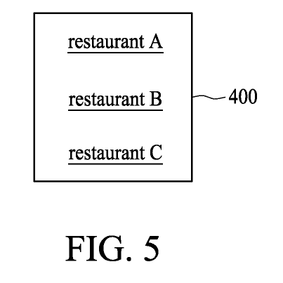

FIG. 5 shows a schematic view of a user interface of a mobile communication device according to another embodiment of the present invention. The mobile communication device 110 displays the optimized information on its screen. As shown in FIG. 5, the display order of the restaurants A, B and C may be based on the distances of the restaurants A, B and C and the user 160, users' endorsements of the restaurants A, B and C, the amount of advertising purchased by the restaurants A, B and C or the features of the restaurants A, B and C.

Referring to FIG. 3, in step S6, an advertisement engine, which is in the content aggregating apparatus 120, transmits advertisements through the Internet 150 to the mobile communication device 110 according to the keyword restaurant, the location of the mobile communication device 110 and an advertising policy. The advertisement may be a text message or a graphic, such as discount information or bar code. In this embodiment, the advertisement is a discount ticket or the information of discount time period. The advertisement is transmitted to the mobile communication device 110 through the Internet based on a protocol between the mobile communication device 110 and the content aggregating apparatus 120, not through a switchboard in a telephone office. Therefore, the transmission of the advertisement will not be charged by ISPs, and the cost is reduced accordingly. In step S7, the watchdog program installed in the mobile communication device 110 generates a short message or a multimedia message service (MMS) message according to the advertisement and stores the message in an inbox 1103 of the mobile communication device 110. In step S8, the inbox 1103 notifies the user 160 of the message stored in the inbox 1103. The user 160 reads the short message or the MMS message from the inbox 1103 of the mobile communication device 110, which is consistent with an ordinary user's habit when reading a message sent by ISPs and is therefore convenient to the user 160.

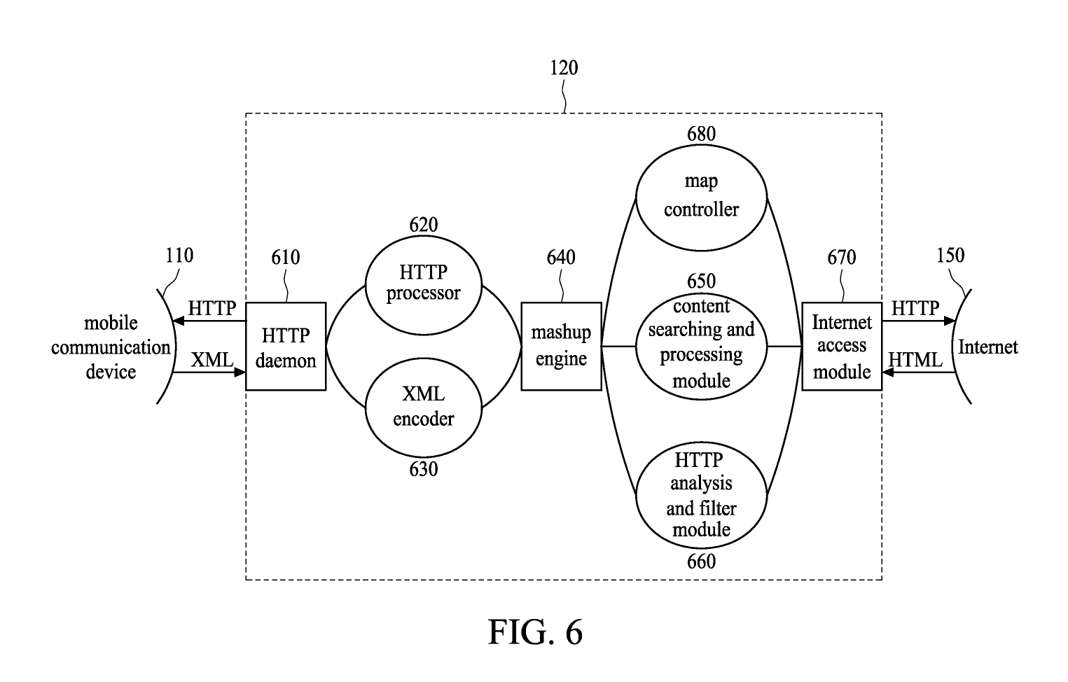

FIG. 6 shows a content aggregating apparatus according to one embodiment of the present invention. The content aggregating apparatus 120 comprises an HTTP daemon 610, an HTTP processor 620, an XML encoder 630, a mashup engine 640, a content searching and processing module 650, an HTTP analysis and filter module 660 and an Internet access module 670.

The HTTP daemon 610 is connected with the mobile communication device 110, and is configured to fetch an HTTP search instruction from the mobile communication device 110 to transmit a uniform resource identifier (URI) to the HTTP processor 620. The mobile communication device 110 may be a mobile phone, a video phone or a personal digital assistant. The HTTP processor 620 extracts instructions and parameters from the received URI, and forwards the extracted instructions to the mashup engine 640. The mashup engine 640 is configured to exchange data with the HTTP processor 620, the XML encoder 630, the content searching and processing module 650 and the HTTP analysis and filter module 660. The content searching and processing module 650 and the HTTP analysis and filter module 660 are connected to the Internet 150 via the Internet access module 670. The Internet access module 670 transmits HTTP instruction to the Internet 150 and receives HTTP content. The content searching and processing module 650 can search the Internet 150 by a content search application interface, such as Google search application interface. The content searching and processing module 650 can also retrieve information relating to the mobile communication device 110 from a database based on the data of the mobile communication device 110, such as the user account of the mobile communication device 110. The HTTP analysis and filter module 660 is configured to filter, reorder and optimize the search results. The mashup engine 640 is then configured to integrate the optimized search results. The XML encoder 630 is configured to encode the integrated search results in an XML format and transmit the integrated search results to the mobile communication device 110.

Preferably, the content aggregating apparatus 120 further comprises a map controller 680. The map controller 680 can also exchange data with the mashup engine 640, and can also connect to the Internet 150 via the Internet access module 670. The map controller 680 is configured to search the Internet 150 by a content search application interface, such as Google map service, for map information, such as a map with location marks.

As shown in FIG. 6, if the mobile communication device 110 is a mobile phone, it may be constrained by its screen size and may not be capable of displaying in HTTP. The content aggregating apparatus 120 then provides the optimized search results in XML format to the mobile communication device 110 to be displayed.

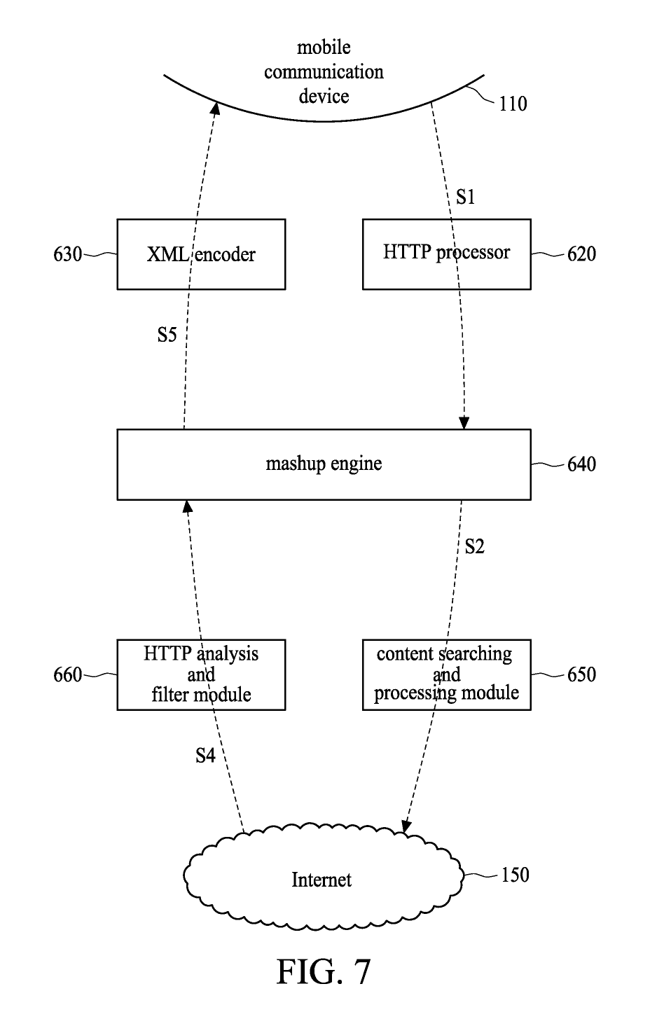

FIG. 7 shows application of the method for transmitting advertisements to a communication device shown in FIG. 2 to the mashup engine 640 of the content aggregating apparatus 120 shown in FIG. 6. In step S1, the mobile communication device 110 transmits the location of the mobile communication device 110 and a keyword to the content aggregating apparatus 120. In step S2, the content searching and processing module 650 of the content aggregating apparatus 120 performs an Internet search. In step S4, the HTTP analysis and filter module 660 of the content aggregating apparatus 120 optimizes the search results. For example, the HTTP analysis and filter module 660 may remove unrelated content, such as other advertisements, from the search results, or the HTTP analysis and filter module 660 may reorder the search results based on specific weightings, such as user endorsement. In step S5, the XML encoder 630 of the content aggregating apparatus 120 converts the optimized results to an XML format and transmits the optimized results via the Internet 150 to the mobile communication device 110.

In conclusion, the method for transmitting advertisements to a communication device of the present invention can integrate content on the Internet and data of other communication devices for users on the Internet or those communication devices. Advertisements relating to search results are also provided to the users, wherein the transmission of the advertisements is not limited to ISPs and will not be charged by ISPs. Therefore, the method for transmitting advertisements to a communication device of the present invention is cost efficient, and the application utilizing the present invention can significantly broaden its application area under the concept of Web 2.0.

The above-described embodiments of the present invention are intended to be illustrative only. Those skilled in the art may devise numerous alternative embodiments without departing from the scope of the following claims.

What is claimed is:

1. A method for transmitting advertisements to a communication device, comprising the steps of:
a communication device transmitting a search instruction to a content aggregating apparatus, wherein the search instruction comprises one or more keywords, the location of the communication device, a user account and a time stamp;
the content aggregating apparatus performing an Internet search based on the keywords and the location of the communication device;
the content aggregating apparatus optimizing the search results;
the content aggregating apparatus transmitting the optimized search results in an extensible markup language (XML) format via the Internet to the communication device;
the content aggregating apparatus transmitting advertisements to the communication device according to the keywords and the location of the communication device;
a watchdog program of the communication device providing a short message to an inbox of the communication device according to the advertisement; and
the inbox notifying a user of the short message stored in the inbox.

2. The method of claim 1, wherein the step of optimizing the search results includes filtering and reordering the search results and removing unrelated content from the search results.

3. The method of claim 2, wherein the reordering step is based on specific weightings.

4. The method of claim 3, wherein the specific weightings are constructed according to users' endorsements of the search results.

5. The method of claim 3, wherein the specific weightings are constructed according to the number of times of the particular search results have been searched.

6. The method of claim 3, wherein the specific weightings are constructed according to advertising policies of the search results.

7. The method of claim 3, wherein the specific weightings are constructed according to the distances between the physical locations of the search results and the location of communication device.

8. The method of claim 1, wherein the content aggregating apparatus transmits advertisements to the communication device according to the keywords, the location of the communication device and an advertising policy.

9. The method of claim 1, wherein the advertisement is a merchandise coupon.

10. The method of claim 1, wherein the advertisement is a text message or a graphic.

11. The method of claim 1, wherein the user account and the time stamp serve as bases for charging advertising fees.

12. The method of claim 1, wherein the communication device is a mobile phone, a video phone or a personal digital assistant.

13. The method of claim 1, wherein the user interface of the communication device comprises a plurality of shortcut keys, wherein the shortcut keys correspond to the displaying of the combinations of the content including news searching, restaurant searching, parking lot searching, shopping, café searching, convenience store searching, friend searching, hotel searching, e-learning and the location of the communication device.

14. The method of claim 1, wherein the location of the communication device is determined by latitude and longitude coordinates provided by a satellite communicating with the communication device or at least a cell Identification (ID) of base stations communicating with the communication device.

15. The method of claim 1, wherein the content aggregating apparatus comprises:
a hypertext transfer protocol (HTTP) processor configured to fetch the search instruction;
a content searching and processing module configured to perform an Internet search based on the given keywords and the location of the communication device;
an HTTP analysis and filter module configured to optimize the search results;
a mashup engine configured to integrate the optimized search results; and
an XML encoder configured to encode the integrated search results in an XML format.

16. The method of claim 15, wherein the HTTP processor is configured to fetch the search instruction from a uniform resource identifier.

17. The method of claim 16, wherein the content aggregating apparatus further comprises:
an HTTP daemon configured to fetch an instruction from the communication device to transmit a uniform resource identifier to the HTTP processor.

18. The method of claim 15, wherein the content aggregating apparatus further comprises:
an Internet access module configured to serve as an interface of the content searching and processing module and the HTTP analysis and filter module to the Internet.

19. The method of claim 15, wherein the content aggregating apparatus further comprises:
a map controller configured to search on the Internet for map information and to provide results to the mashup engine.

20. The method of claim 15, wherein the content searching and processing module is adapted to access preference information stored in the communication device based on data provided by the communication device.

21. The method of claim 20, wherein the data provided by the communication device is a user account of the communication device.
